(19) United States
(12) Patent Application Publication
(10) Pub. No.: US 2006/0080315 A1
(43) Pub. Date: Apr. 13, 2006

(54) Statistical natural language processing algorithm for use with massively parallel relational database management system

(75) Inventor: Jonathon J. Mitchell, New Lebanon, OH (US)

Correspondence Address: WOOD, HERRON & EVANS, LLP, 2700 CAREW TOWER, 441 VINE STREET, CINCINNATI, OH, 45202, US

(73) Assignee: The Greentree Group

(21) Appl. No.: 11/246,371

(22) Filed: Oct. 7, 2005

Related U.S. Application Data
(60) Provisional application No. 60/617,547, filed on Oct. 8, 2004.

(51) Int. Cl. G06F 17/30

(52) U.S. Cl. 707/6

(57) ABSTRACT

A methodology and processing model utilize a unique set of data structures and processing algorithms, which are capable of being leveraged on a Massively Parallel Relational Database Management System (RDBMS) to provide fast, accurate, and scalable access to text data that is stored in these data structures. The methodology relies on a positional co-occurrence-based Statistical Natural Language Processing (SNLP) algorithm, a set of data structures that define the data to be searched and contain the co-occurrence patterns that are created by the SNLP algorithm, a real-time relevancy formula and weighting structure that returns the most relevant documents to the user.

### CROSS-REFERENCE TO RELATED APPLICATIONS

This application claims priority on U.S. Provisional Patent Application Ser. No. 60/617,547, filed Oct. 8, 2004 by Jonathon J. Mitchell, which application is incorporated by reference herein.

### FIELD OF THE INVENTION

The invention is generally directed to computers and computer software. More specifically, the invention is directed to database queries and statistical natural language processing.

### BACKGROUND OF THE INVENTION

Databases are used to store information for an innumerable number of applications, including various commercial, industrial, technical, scientific and educational applications. As the reliance on information increases, the volume of information stored in most databases increases. Furthermore, as the volume of information in a database increases, the amount of computing resources required to manage such a database and to extract desired data from the database increases as well.

Database management systems (DBMS's), and in particular, Relational Database Management Systems (RDBMS's), which are the computer programs that are used to access the information stored in databases, often require tremendous resources to handle the heavy workloads placed on such systems. As such, significant resources have been devoted to increasing the performance of database management systems with respect to processing searches, or queries, to databases.

For example, significant development efforts have been directed to Massively Parallel RDBMS's, which are often capable of storing and accessing terabytes or more of data, using virtual processors that are mapped to particular sets of data distributed across a number of high capacity storage devices. Database queries are broken into units of work that can be handled in parallel, with different virtual processors assigned to handle those units of work. The results computed for each unit of work are then combined to generate the overall result of the query.

RDBMS's have found use in a number of applications. For example, RDBMS's are often used in search engine applications to access specific data based upon queries generated by users and/or application programs. RDBMS's are also used in data mining applications, where attempts are made to detect interesting patterns, trends and relationships in large volumes of data where such patterns, trends and relationships might not otherwise be particularly apparent to the casual user.

Many modern data mining applications, for example, use indexing structures of HTML (web) or text information, and some store these indexes in RDBMS's. However, in many instances, these data mining applications do not utilize the built in storage, indexing, join processing, and analytic capabilities of an RDBMS to do the searching and pattern matching directly in the RDBMS. Furthermore, often these applications do not scale well to large volumes of information.

A number of Statistical Natural Language Processing (SNLP) techniques have been developed to improve the quality of the results generated from database queries, in particular for collections of text-based data. For example, Latent Semantic Indexing (LSI) is a SNLP technique that measures word/document similarity using Singular Value Decomposition (SVD) to find the words that are closest in similarity and documents that are closest in meaning. However, it has been found that such techniques often suffer from a number of shortcomings.

First, conventional SNLP techniques are rarely scalable. For example, LSI, in utilizing SVD, is typically limited to small text collections and is extremely computer resource expensive because of the size of the matrices that must be constructed and decomposed. For large text collections, e.g., of a terabyte of data or more, the amount of time and resources required to even preprocess the text collection can be prohibitive.

Second, although conventional SNLP techniques are typically language independent, meaning that they can be used to find similarity in a collection of text documents in any language because they use the entire collection as the basis for word/document similarity, the effectiveness of the similarity measures are typically limited to the context or collective meaning in the text collection that was used to build the SVD matrices. There has been no effective methodology put forth to allow these techniques to scale to correctly measure similarity across a text collection where the data is not focused on a particular subject matter or collective meaning.

Third, conventional SNLP techniques are also typically limited in terms of the scope of the search and pattern matching capability because they do not consider the position or context of the words in the document. In order to find specific phrases a search of the text must be performed directly. Problems with ambiguity also occur with these models such as with the word “bank”. Bank can refer to a financial institution and among others the ground along side a river or stream. These models also do not consider parts of speech as relevant to the overall processing model. Again using “bank” as our example, “to bank in a shot” (such as in basketball) and “that bank offers free checking”, have entirely different meanings when bank is used as a verb vs. a noun.

Furthermore, as the amount and types of data that are integrated into enterprise-wide RDBMS's, the limitations of conventional SNLP techniques become more pronounced. In particular, as information analysis becomes more complex and sophisticated, the amount and variety of types of information being analyzed, and the complexity of the questions being answered, increase.

For instance, many organizations have traditionally maintained separate databases for various types of information, e.g., sales information, personnel information, engineering information, accounting information, facilities information, etc. More recently, however, many organizations have begun to appreciate the benefits of integrating these disparate types of information into a common data warehouse (or at least a common point of access) so that questions that require analysis of different types of information can potentially be answered.

For example, suppose an organization desired to monitor for fraud or information leaks in the organization, where the organization had available various types of information related to fraud or leak detection, e.g., personnel data, sales data, system access audit data, electronic messaging (email) data, instant messaging traffic data, network share data, and call center phone log data. In the event of an information leak, it would be beneficial to such an organization to be able to query all of the relevant organizational information to determine the answers to such questions as: “who had access to the leaked information”, “who actually accessed the leaked information”, and “who communicated the leaked information outside of the organization.” For large organizations having thousands or tens of thousands of employees, the search space may be prohibitively large for analysis using conventional tools.

Conventional SNLP techniques, which are constrained in terms of scalability and in operating on information that is not centered around a particular context or collective meaning, are not well suited for such environments, or for answering the types of questions that such environments demand. Therefore, a significant need exists in the art for an improved SNLP technique that has greater scalability and flexibility than conventional techniques.

### SUMMARY OF THE INVENTION

Accordingly, aspects of the present invention relate to a methodology and processing model that utilize a unique set of data structures and processing algorithms, which are flexible and scalable, and readily suited for use in a parallel environment such as a Massively Parallel RDBMS. The herein-described methodology relies on a positional co-occurrence-based Statistical Natural Language Processing (SNLP) algorithm, a set of data structures that define the data to be searched and contain the co-occurrence patterns that are created by the SNLP algorithm, and a real-time relevancy formula and weighting structure that returns the most relevant documents to the user.

In the illustrated embodiments, a text collection is analyzed to identify co-occurrence patterns among combinations of terms in the text collection, where the co-occurrence patterns indicate the frequency of occurrence of particular term combinations over multiple positional variances, i.e., distances between terms in the combinations. From such co-occurrence patterns, queries may be initiated on the text collection through a process of calculating values referred to as term variances for term combinations associated with such queries at different positional variances. Such term variances may then be used to generate query sets that are used to query a text collection for particular term combinations at particular positional variances.

Consistent with one aspect of the invention, therefore, co-occurrence patterns may be identified in a text collection by identifying a combination of terms found in at least one of a plurality of documents in a text collection, and calculating co-occurrences of the combination of terms at each of a plurality of positional variances between the combination of terms.

Consistent with another aspect of the invention, a query may be processed by calculating a plurality of term variances for at least one term combination associated with a query, generating a query set based upon the plurality of calculated term variances, and querying a text collection using the generated query set, where each term variance is associated with a specific positional variance between the term combination.

Consistent with yet another aspect of the invention, a query may be processed by selecting, for at least one term combination associated with a query, at least one positional variance between the terms in the term combination, based upon a co-occurrence of the terms in the term combination in a text collection at the positional variance, and querying the text collection to identify documents in the text collection having the terms in the term combination at the selected positional variance.

Additional advantages of the present invention will be come readily apparent to those skilled in this art from the detailed description, where only preferred embodiments of the invention is shown and described, simply by illustration. As will be realized the invention is capable of being implemented in other and different embodiments such as in different programming languages and/or on different database platforms, and its several details are capable of modification in various obvious results, all without departing from the invention. Accordingly the drawings, description and programming code samples are to be regarded as illustrative in nature, and not as restrictive.

### DESCRIPTION OF THE DRAWINGS

FIG. 1 illustrates an exemplary graphical representation of a positional co-occurrence between two exemplary terms in a data collection, representing the relationship between the distance between terms and the frequency those terms exist in a given collection.

FIG. 2 illustrates an exemplary data model for storing data from a collection for use in connection with positional co-occurrence analysis consistent with the invention.

FIG. 3 illustrates exemplary indexes that may be created on the exemplary data model of FIG. 2.

FIG. 4 illustrates an exemplary query suitable for use in building the co_occurrence_with_spacing table of FIG. 2.

FIG. 5 is a flowchart illustrating the program flow of an exemplary method for calculating weighted term variances for a query set.

FIG. 6 illustrates an exemplary query suitable for use in calculating a weighted term variance between two terms.

FIG. 7 illustrates an exemplary query suitable for use in calculating a weighted term variance between four terms.

FIG. 8 illustrates a representative result set generated for an exemplary implementation of the query of FIG. 7, utilizing the search terms ‘treatment research colon cancer’.

FIG. 9 is a flowchart illustrating the program flow of an exemplary method for generating a result set from a query set generated using the method of FIG. 5.

FIG. 10 illustrates an exemplary query suitable for use in generating a result set using an aggregated weighted term variance based upon the top three weighted term variance sets from the result set of FIG. 8.

FIG. 11 illustrates an exemplary result set generated by the query of FIG. 10.

FIG. 12 is a flowchart illustrating the program flow of an exemplary method for expanding a query set based upon term context.

FIG. 13 illustrates an exemplary hardware environment upon which embodiments consistent with the invention may be implemented.

### DETAILED DESCRIPTION

Embodiments consistent with the invention utilize a statistical natural language processing methodology referred to herein as “positional co-occurrence” to provide a scalable and flexible manner of generating queries for a database, e.g., using a massively parallel RDBMS. A discussion of the methodology will precede a discussion of exemplary implementations for accessing a collection of data utilizing the methodology.

Positional Co-Occurrence Methodology

As noted above, embodiments consistent with the invention utilize a SNLP methodology to facilitate the access to a text collection in a database. The methodology is premised on the fact that, over a large collection of text, and at an ever increasing degree of precision, the common distance between words and the frequency at which those distances occur tend to indicate a strong or weak relationship between words and word structures. Thus, unlike SVD techniques that merely look at the number of times terms may appear together in the same document, the present methodology additionally looks at the position of terms relative to one another. These positional relationships are termed co-occurrence patterns, and generally represent the frequency of co-occurrence for combinations of terms at multiple positional variances.

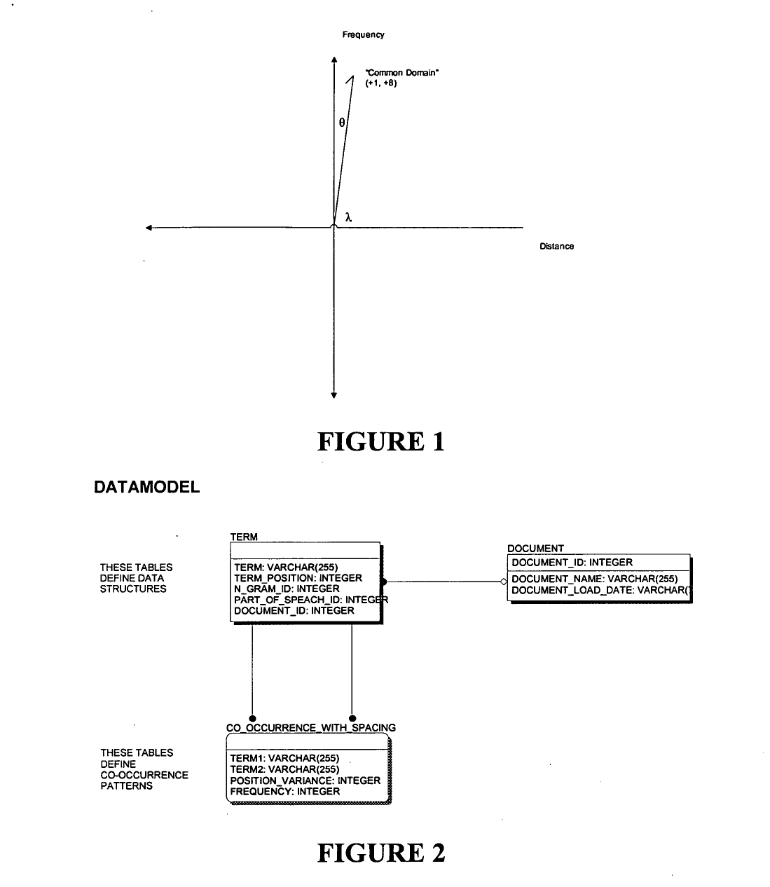

FIG. 1, for example, illustrates an exemplary a graph of a positional co-occurrence pattern, which is a coordinate representation of the variance of the distance between two terms and the frequency that they occur in a given collection. The X axis represents a positional distance between words as they occur in context. The Y axis represents the frequency at which two words occur at a specific distance. For this example, the phrase “Common Domain” occurring eight times in a text document would have an X coordinate of 1 and a Y coordinate of 8.

The coordinate (X,Y) as exemplified in FIG. 1 is graphed as the Vector x. The angle θ (denoted by the sin x) is directly affected by frequency measure of the co-occurrence of the two terms. As this approaches 0° the words are seen together frequently. This can, at an ever increasing rate, indicate that the two words are a bi-gram or two words that have a distinct meaning in context, independent of their individual meanings. This can also indicate co-dependence where one word, is modified or expanded upon with the other word. The other angle λ (denoted by cos x) is directly affected by the distance measure between two words. As this angle approaches 0° the two words are found farther apart in text. This indicates words that do not belong together or are not directly related. The result of these calculations provides indicators of “Common Domains” or words that exist and are used together to discuss, relate or describe events or things in a common domain of interest. These indicators may be calculated by examining the co-occurrence of terms across an entire collection of documents. These indicators are referred to as “term variances”, or Z-factors, which effectively represent one term's relevancy to another term within the context of a text collection.

As will be discussed in greater detail below, the term variances may optionally be weighted or scaled to either emphasize or de-emphasize terms that are positioned closer together or farther away, based upon the types of queries that are desired. As used herein, however, a term variance need not be weighted in all implementations of the invention.

As will also be discussed in greater detail below, the term variances may be used to generate query sets from queries generated by an application or a user to attempt to formulate optimal queries and/or identify the most relevant query results for a given collection of data.

For example, in the embodiments discussed hereinafter, the term variances are used to select, from among a plurality of terms input as a query by a user or application, one or more term combinations having the highest term variances. These term combinations are then used to query a text collection to identify the documents matching those term combinations, typically with the queries to the text collection specifying the positional variance, or distance, for each term combination (i.e., for a term combination of “cancer” and “treatment” with a positional variance of 3, the query would search for documents where the terms “cancer” and “treatment” were found three positions apart from one another.) Typically, each returned document is assigned an aggregated term variance based upon the term variance for each matching term combination, and the documents in the result set are then ranked or sorted by the aggregated term variance, whereby those documents having the highest aggregated term variances are deemed to be the most relevant documents from the result set.

It will be appreciated by one of ordinary skill in the art having the benefit of the instant disclosure that a number of variations on the herein-described methodology may be implemented consistent with the invention. Moreover, other aspects and variations of the herein-described methodology will be discussed in greater detail below.

Logical and Physical Data Model

A relational database model is desirably used to store the text data, its association to a body of text, or document, its position within the document, and optionally the part of speech that each word that makes up the text data is as it was used in the context of the document. FIG. 2, for example, is one exemplary implementation of the data model, where each document is defined to include an identifier, document name and load date, and where each term is defined to include a position value, a part of speech indicator and a reference to the document ID of the document within which the term is found. The position of the term may be based upon the terms position relative to other terms in the document, starting from the beginning. For example, the beginning position may be denoted with the number 1 and every subsequent term may be given an incremental position within that document.

The data model of FIG. 2 also includes a co-occurrence with spacing table which forms one of the foundational computational pieces of the methodology. The table links to two terms and includes a positional variance that indicates the distance between the terms, as well as a frequency that indicates the number of times the terms occur with the specific positional variance in the overall text collection. It will be appreciated that in other environments, a co-occurrence table may be generated for positional variances between more than two terms, as is the case with the data model of FIG. 2.

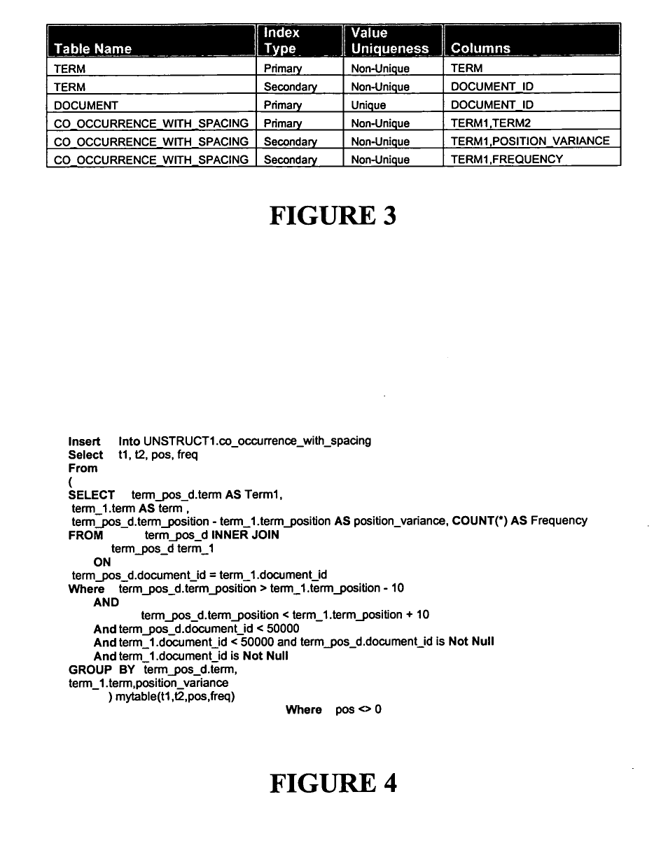

While not required, it may be desirable to optimize access to the data model of FIG. 2, e.g., by generating indexes that are associated with tables that provide quick access to specific column data. These indexes serve to assist in data searches and scans that increase the speed of queries. Because embodiments of the invention are desirably implemented in a Massively Parallel RDBMS, indexes are used to provide a responsive and scalable implementation. FIG. 3 illustrates exemplary indexes that define the particular index criteria for the exemplary platform upon which the invention may be implemented.

As noted above, the co-occurrence with spacing table is one of the foundational computational pieces of the methodology. FIG. 4 illustrates one exemplary query that may be used to build the co_occurrence_with spacing table, optionally after a preprocessing phase (discussed hereinafter) as been performed to initially load a text collection into an RDBMS. This query does a self join on the term table to calculate the co-occurrence of terms within each document and aggregates the frequency of each positional variance within the entire collection. This query exemplifies an initial query that may be initiated to start the population of the co_occurrence_with_spacing table on a collection with greater than 50,000 documents. A variant of this query that runs against documents loaded after this initial query may be implemented in an operational RDBMS as a background process, constantly updating the positional variance and frequency counts between words over the entire collection. It will be appreciated that the implementation of such a query would we within the abilities of one of ordinary skill in the art having the benefit of the instant disclosure. Moreover, it will be appreciated that the herein-described query implementation is well suited for use in a parallel RDBMS system such as a Massively Parallel RDBMS.

In addition, it will be appreciated that, rather than building the co-occurrence with spacing table as a batch process as shown herein, the co-occurrence patterns in a text collection may be generated on-the-fly, i.e., in response to a particular query.

Text Collection Preprocessing

In some implementations, it may be desirable to preprocess the information in a text collection, which may be performed in a software application outside of an RDBMS if desired. One of ordinary skill would recognize that the preprocessing task could be accomplished in a variety of ways. The specific tasks that may be considered in this preprocessing phase include, but are not necessarily limited to the following steps:

1. Separate a text document into its terms

2. Utilize a Natural Language Processing Part of Speech Tagger to tag the terms with the part of speech they are in context.

3. Record each individual term's position in the document.

4. Create two files:
a. File one contains the document information that is used to load the document table.
b. File two contains the term, position, and part of speech information that is used to load the term table.

5. Load the two files, separately into the RDBMS.

In one exemplary embodiment the loading programs are MLOAD scripts that are run against the load files created by a preprocessing engine. These files may be designed to constantly add new information to the data structure.

Term Variance Calculation

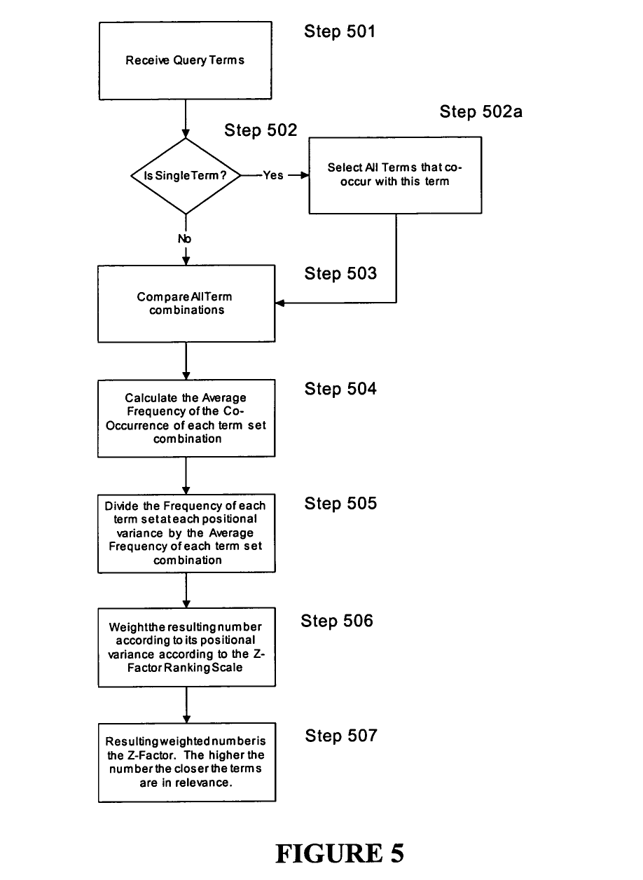

As discussed above, term variances, also referred to herein as Z-factors, may be used to generate query sets from queries generated by an application or a user. FIG. 5, for example, illustrates a flowchart of an exemplary method for the Z-Factor calculation of a query set. In step 501, a query term or query phrase, set of terms, is established. In step 502, the query is analyzed as to its number of terms. If there is only one term step 502a is executed. In this step a query is executed against the Co_Occurrence_with_Spacing table to get the terms with the n-highest frequencies and closest positions to the singular term. These new terms are then used in step 503. If in step 502 there are multiple terms, the methodology proceeds to step 503 using the terms provided to the method. In other embodiments, however, even multi-term queries may be expanded in the manner shown in FIG. 5 for a single term query.

Step 503 begins the Z-factor calculation process. The term variance, or Z-factor, may be implemented as the frequency of two terms co-occurring at a given distance divided by the average frequency of the co-occurrence of the two terms co-occurning at any distance. This is illustrated in steps 504 and 505. In step 506, this factor is then weighted based on the distance between the two words on the following scale:

### Z-Factor Ranking Scale

If the value of the Positional variance=−1 multiply the average factor by 1.2 to get the Z-Factor.

If the Absolute value of the Positional variance<2 (0, 1) multiply the average factor by 0.8 to get the Z-Factor.

If the Absolute value of the Positional variance=2 or 3 multiply the average factor by 0.7 to get the Z-Factor.

If the Absolute value of the Positional variance=4 multiply the average factor by 0.6 to get the Z-Factor.

If the Absolute value of the Positional variance=5 multiply the average factor by 0.5 to get the Z-Factor.

If the Absolute value of the Positional variance=6 multiply the average factor by 0.4 to get the Z-Factor.

If the Absolute value of the Positional variance=7 multiply the average factor by 0.3 to get the Z-Factor.

If the Absolute value of the Positional variance=8 multiply the average factor by 0.2 to get the Z-Factor.

If the Absolute value of the Positional variance=9 multiply the average factor by 0.1 to get the Z-Factor.

If the Absolute value of the Positional variance>=10 (10+) multiply the average factor by 0.1 to get the Z-Factor.

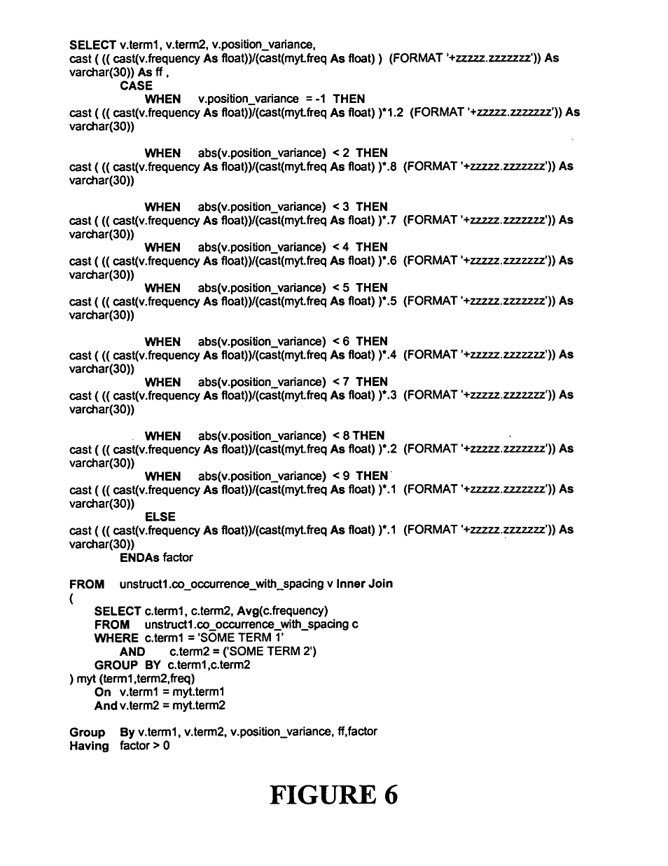

In this exemplary method for implementing this methodology the weighting may be performed in a single step via a SQL Query in the RDBMS. FIG. 6 illustrates one exemplary SQL Query where ‘SOME TERM 1’ and ‘SOME TERM 2’ are the two terms for which it is desired to calculate a Z-Factor. If no occurrences of these two terms occur, an empty result set will be generated, indicating there is no relationship between the two terms. For Example, if one was to use the two terms ‘river’ and ‘bank’ one would get a strong Z-Factor (Greater than 1), whereas if one was to use the two terms ‘river’ and ‘computer’ one would tend to get a low Z-Factor.

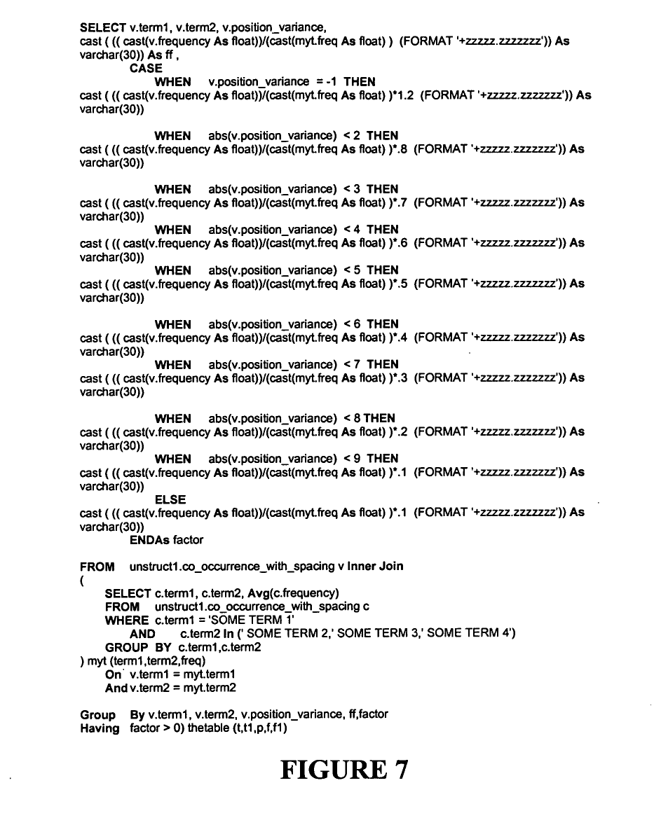

For multi-term queries or phrase searches the query of FIG. 6 may be expanded, as illustrated in FIG. 7. This returns a result set that calculates the highest Z-factors of any combination of the search terms in any position and returns these highest values. In this query ‘SOME TERM 1’, ‘SOME TERM 2’, ‘SOME TERM 3’ and ‘SOME TERM 4’ are each inserted as ‘SOME TERM 1’ with the remaining terms inserted in the query as alternate values for c.term2.

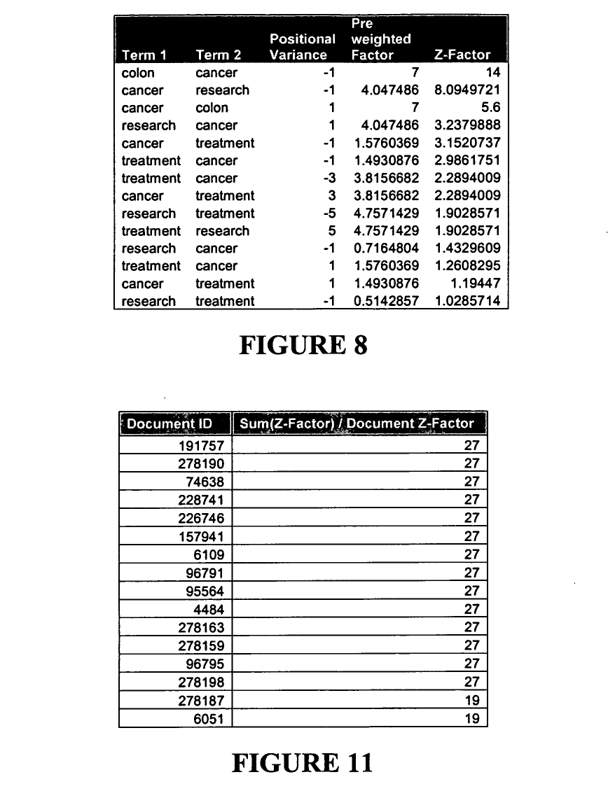

As an example, FIG. 8 illustrates a representative result set for an exemplary implementation of the methodology as might be returned by a query on an exemplary text collection using the search terms ‘treatment research colon cancer’. The values indicate that the phrases ‘colon cancer’, ‘cancer research’ and ‘cancer colon’ have the highest term variances for the text collection. This final result is represented in step 507 of FIG. 5.

It will be appreciated that a wide variety of alternate weighting algorithms may be used consistent with the invention. In addition, such weighting algorithms may be determined empirically in some embodiments.

Result Set Generation

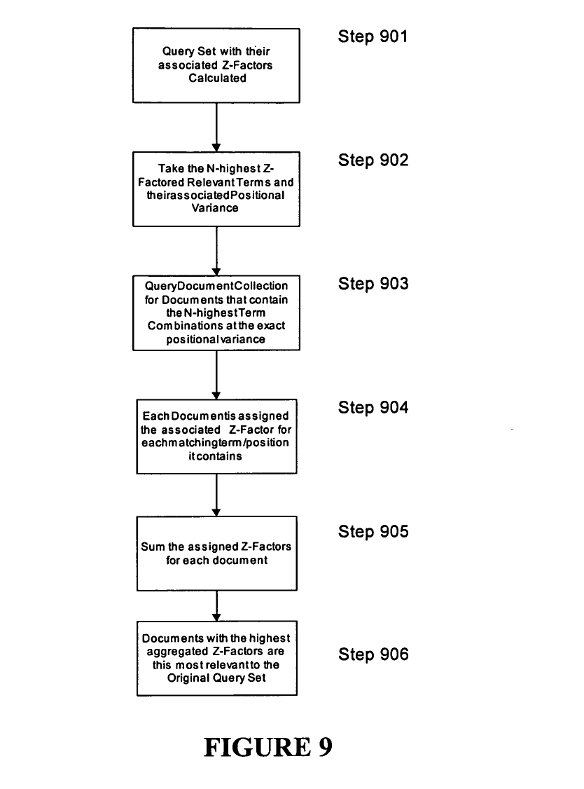

Once the most relevant term combinations are identified in the method of FIG. 5, a result set from the text collection may be generated by calculating the aggregate Z-Factor of documents that contain the n-highest term combinations. This process is illustrated in FIG. 9. In particular, the values from step 507 in FIG. 5 are used as input to step 901. In step 902 the n-highest Z-Factor terms and their associated positional variances are selected. FIG. 8 illustrates an exemplary result of this step. This provides the term to term positioning that is the most similar to the original query.

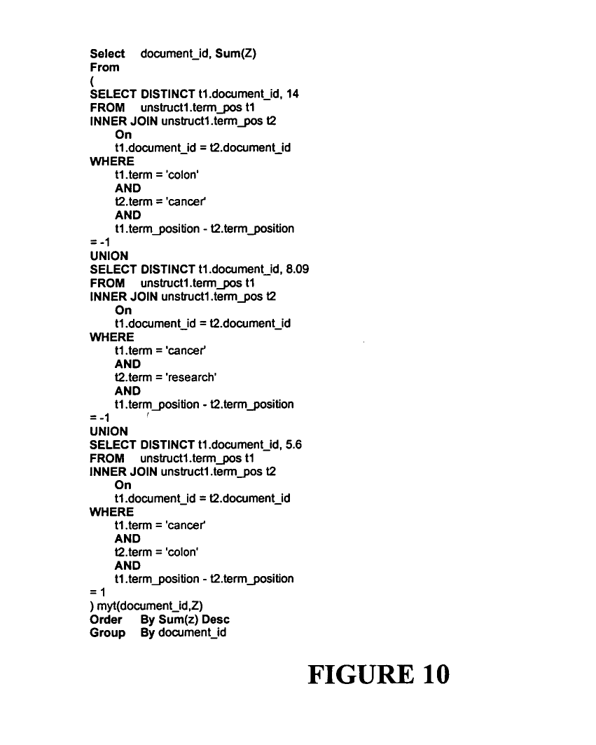

Step 903 of FIG. 9 is a search of the document collection for the term combinations at the exact positional variances selected in step 902. In step 904, each document is assigned the associated Z-Factor for each matching term combination at the exact positional variance. In Step 905 these associated Z-Factors are summed at the document level. This logic, steps 903-905, is exemplified in a SQL query illustrated in FIG. 10, which continues the aforementioned example and takes the three highest (most relevant) term combinations. A sample illustration of the final result, of a document list with the highest aggregated Z-Factors (step 906), is shown in FIG. 11. This list illustrates those documents relating most closely to the original search phrase ‘treatment research colon cancer’.

It will be appreciated that different numbers of the term combinations identified as a result of term variance calculations may be used in a query set input to step 901, e.g., taking only the top term combination. In addition, it will be appreciated that rather than being used to expand the query set, the term combinations identified as a result of term variance calculations may be used to sort or rank a result set generated from processing the original query input by a user or application, i.e., whereas no modification or optimization of the query submitted to the database is performed.

Lexigraphical Query Set Exansion

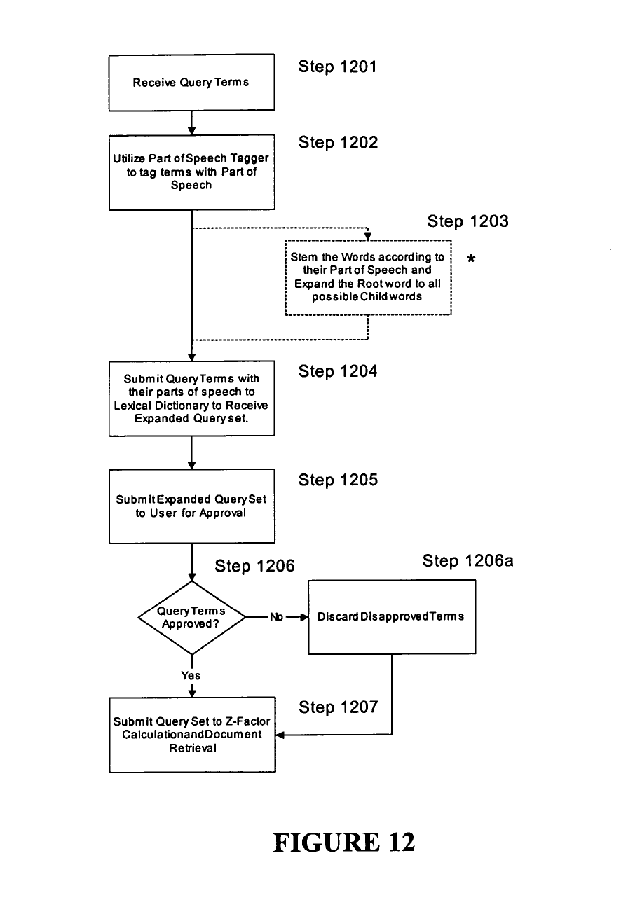

In some embodiments consistent with the invention, it may also be desirable to optionally expand a query set to address issues of ambiguity and thought or context surrounding search terms and a text collection. FIG. 12 illustrates a flowchart of this process. In step 1201, the query term or terms is submitted. In step 1202, a Natural Language Part of Speech tagger is utilized to pre-analyze the query in order to identify the thought or concept behind the query term or terms. In this exemplary implementation the following example is used: If the user enters ‘river bank’ the Part of Speech tagger will tag river as an adjective and bank as a noun. In step 1204 these terms and their associated parts of speech are used as input into a lexical dictionary to further analyze the thought or concept behind the query. This function allows this methodology to take advantage of user defined relationships between words by examining them in context. In this exemplary illustration the methodology may utilize the WordNet API 2.0 developed by Princeton University Cognitive Science Lab Copyright 1991-2003. One of ordinary skill will notice that the location of the lexical dictionary, software API, or source of the construction will not affect this implementation. However, the accuracy and context surrounding the lexical dictionary will directly affect the result set.

In step 1205 this expanded query set received from the lexical dictionary in step 1204 is resubmitted to the user. In step 1206 the user is asked to approve or disapprove the expanded term listing. This allows direct user input as to whether they want to expand the query base or refine the contextual meaning behind their query. If the user disapproves a term(s) step 1206a will remove them from the list. For all approved terms, they are submitted the Z-Factor calculation process in step 1207.

It will be appreciated that in some embodiments, no user prompting may be used, whereby all expansions of the query set may be submitted to the Z-Factor calculation process. In addition, in some embodiments it may also be desirable to analyze sentence structure, e.g., to identify terms that are the objects of other terms within the context of a “subject verb object” type of sentence structure, since it is likely that the subject and object of such a sentence structure would have some form of contextual relationship.

Also, as illustrated in FIG. 12, and in particular in step 1203, it may also be desirable to perform stemming to reduce a term to its root and expand the query set to suitable variations based upon the part of speech of the term. One of ordinary skill will be able to understand that the process of stemming query terms has the net result of reducing the scope of possible searches. One of ordinary skill will also be able to understand that the process of stemming a set of terms may be valuable in thought or context examination and query expansion. Stemming can be used to examine all possible roots of a search term and the subsequent child terms of each of those roots. This process may be used to assist in expanding the context of the search terms.

In some instances, however, stemming may have several disadvantages, and thus may not be desired. First, words seldom exist as stand-alone entities. Second, words innately have meaning in the context in which they are used, and subtle differences in context can sometimes lead to mistaken meaning. Ambiguities that exist between words may also be ignored. For example, the root of a word can have multiple meanings as in the case of “bank” given earlier.

Hardware Environment

As mentioned above, the embodiments discussed herein desirably utilize a Massively Parallel RDBMS for storing a unique set of data structures and processing algorithms supporting the scalable, accurate processing of textual information for analysis purposes. A brief discussion will be provided regarding an exemplary hardware and software environment within which such a process may reside.

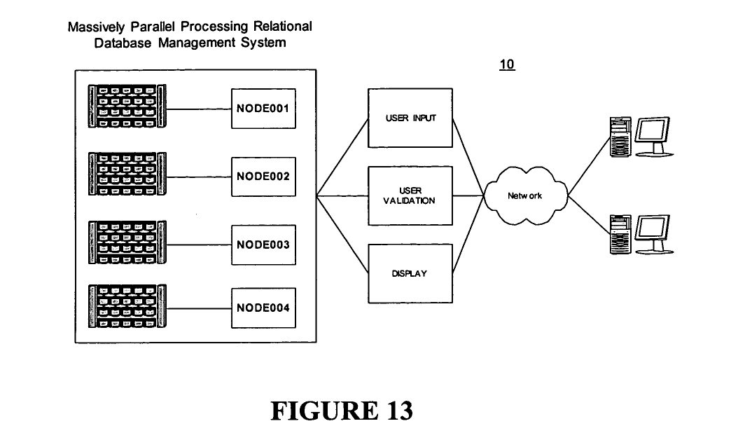

FIG. 13 illustrates an exemplary hardware and software environment for an apparatus 10 suitable for implementing Co-Occurrence-With-Spacing SNLP and Massively Parallel RDBMS set of data structures, queries and indexes consistent with this invention. This hardware environment may be implemented, for example, in an NCR Teradata 4850 MPP System with 4 Nodes.

For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 may also be referred to as a “computer,” although it should be appreciated that the term “apparatus” may also include other suitable programmable electronic devices consistent with the invention, and may even include subcomponents of any programmable electronic device, e.g., a computer readable medium with program code stored thereon.

In the illustrated embodiment, apparatus 10 is implemented as a Massively Parallel RDBMS, and the exemplary implementation discussed herein has been tailored to the hardware and software environment described herein. The exact processing algorithms, data structures and associated indexes may need to be modified on a hardware and software platform not consistent with the one described herein.

Computer 10 typically includes a central processing unit (CPU) including one or more microprocessors coupled to a memory, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, the memory may be considered to include memory storage physically located elsewhere in computer 10, e.g., any cache memory in a processor in a CPU, as well as any storage capacity used as a virtual memory, e.g., as stored on a mass storage device or on another computer coupled to computer 10.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention may be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution, e.g., tangible, recordable type media such as volatile and non-volatile memory devices, floppy and other removable disks, hard disk drives, magnetic tape, optical disks (e.g., CD-ROMs, DVDs, etc.), and transmission type media such as digital and analog communication links.

In addition, various program code described herein may be identified based upon the application within which it is implemented in a specific embodiment of the invention. However, it should be appreciated that any particular program nomenclature used herein is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the organization and allocation of program functionality described herein.

Those skilled in the art will recognize that the exemplary environment illustrated in FIG. 13 is not intended to limit the present invention. Indeed, those skilled in the art will recognize that other alternative hardware and/or software environments may be used without departing from the scope of the invention.

Although the present invention has been described and illustrated in detail, it is clearly understood that the same is by way of illustration and example only and is not to be taken by way of limitation, the spirit and scope of the present invention being limited by the terms of the appended claims and their equivalents. For example, it will be appreciated that the principles of the invention may be utilized to search practically any text collection, whether stored in a single database or multiple databases, and regardless of what format the text is in, or whether additional non-text data is stored in the same database(s). Furthermore, it will be appreciated that the invention may be utilized in connection with performing Internet searches. Various additional modifications will be apparent to one of ordinary skill in the art having the benefit of the instant disclosure.

What is claimed is:

1. A method for identifying a co-occurrence pattern in a text collection, comprising:
identifying a combination of terms found in at least one of a plurality of documents in a text collection; and
calculating co-occurrences of the combination of terms at each of a plurality of positional variances between the combination of terms.

2. The method of claim 1, further comprising:
identifying a plurality of combinations of terms in the text collection; and
for each of the plurality of combinations of terms, calculating co-occurrences thereof at each of a plurality of positional variances therebetween.

3. The method of claim 2, further comprising processing a query on the text collection using the calculated co-occurrences for the plurality of combinations of terms.

4. The method of claim 3, wherein processing the query includes generating a query set including at least one combination of terms for which a co-occurrence has been calculated and a positional variance therefor.

5. The method of claim 4, wherein generating the query set further includes calculating a plurality of term variances for each of a plurality of combinations of terms, wherein each term variance for each combination of terms is associated with a specific positional variance between the terms in the combination of terms.

6. The method of claim 5, wherein generating the query set further includes selecting a subset of the plurality of combinations of terms for inclusion in the query set based upon the plurality of term variances, each combination of terms in the selected subset having associated therewith a specific positional variance.

7. The method of claim 6, wherein processing the query further includes searching the text collection for each combination of terms in the selected subset at the specific positional variance associated therewith.

8. The method of claim 7, wherein processing the query further includes ranking each of a plurality of matching documents from the text collection based upon an aggregation of the term variances for those combinations of terms in the selected subset that are found in such matching document.

9. The method of claim 4, wherein generating the query set includes stemming a first term and generating at least one term variant therefor.

10. The method of claim 1, further comprising preprocessing the text collection to identify a part of speech for at least a subset of the plurality of terms.

11. A method for processing a query, comprising:
calculating a plurality of term variances for at least one term combination associated with a query, wherein each term variance is associated with a specific positional variance between the term combination;
generating a query set based upon the plurality of calculated term variances; and
querying a text collection using the generated query set.

12. The method of claim 11, wherein calculating the plurality of term variances includes calculating a plurality of term variances for each of a plurality of term combinations associated with the query, and wherein generating the query set includes selecting a subset of the plurality of term combinations and associated positional variances therefor based upon the respective term variances of the plurality of term combinations.

13. The method of claim 12, wherein calculating the plurality of term variances includes, for each positional variance, calculating the term variance therefor by dividing a number of co-occurrences of the term combination at such positional variance in the text collection by an average frequency of co-occurrence for the term combination over all positional variances.

14. The method of claim 13, wherein calculating the plurality of term variances further includes weighting each term variance based upon the positional variance associated therewith.

15. The method of claim 14, wherein weighting each term variance comprises, for each term variance:
if the positional variance associated therewith=−1, multiplying the term variance by 1.2;
if the positional variance associated therewith=0 or 1, multiplying the term variance by 0.8;
if the absolute positional variance associated therewith=2 or 3, multiplying the term variance by 0.7;
if the absolute positional variance associated therewith=4, multiplying the term variance by 0.6;
if the absolute positional variance associated therewith=5, multiplying the term variance by 0.5;
if the absolute positional variance associated therewith=6, multiplying the term variance by 0.4;
if the absolute positional variance associated therewith=7, multiplying the term variance by 0.3;
if the absolute positional variance associated therewith=8, multiplying the term variance by 0.2;
if the absolute positional variance associated therewith=9, multiplying the term variance by 0.1; and
if the absolute positional variance associated therewith>=10, multiplying the term variance by 0.1.

16. The method of claim 12, wherein querying the text collection includes searching the text collection for each term combination in the selected subset at the specific positional variance associated therewith.

17. The method of claim 16, wherein querying the text collection further includes ranking each of a plurality of matching documents from the text collection based upon an aggregation of the term variances for those term combinations in the selected subset that are found in such matching document.

18. The method of claim 11, further comprising creating the term combination from first and second input query terms.

19. The method of claim 11, further comprising creating the term combination from an input query term and a second term determined by querying co-occurrence data for a term having a high frequency of co-occurrence with the input query term.

20. The method of claim 11, wherein generating the query set further includes:
tagging at least one term in the query set with a part of speech;
stemming the at least one term to its root and expanding the root to its child terms;
expanding the query set by utilizing a lexical dictionary; and
submitting the query set for user approval.

21. A method for processing a query, comprising:
selecting, for at least one term combination associated with a query, at least one positional variance between the terms in the term combination, based upon a co-occurrence of the terms in the term combination in a text collection at the positional variance; and
querying the text collection to identify documents in the text collection having the terms in the term combination at the selected positional variance.

22. The method of claim 21, wherein selecting the positional variance includes calculating a plurality of term variances for the term combination at each of a plurality of positional variances.

23. The method of claim 22, wherein calculating the plurality of term variances includes, for each positional variance, calculating the term variance therefor by dividing a number of co-occurrences of the term combination at such positional variance in the text collection by an average frequency of co-occurrence for the term combination over all positional variances.

24. The method of claim 23, wherein calculating the plurality of term variances further includes weighting each term variance based upon the positional variance associated therewith.

25. The method of claim 22, wherein querying the text collection further includes ranking each identified document based upon an aggregation of term variances.

26. An apparatus, comprising:
a computer readable medium; and
program code resident in the computer readable medium and configured to identify a co-occurrence pattern in a text collection by identifying a combination of terms found in at least one of a plurality of documents in the text collection and calculating co-occurrences of the combination of terms at each of a plurality of positional variances between the combination of terms.

27. The apparatus of claim 26, further comprising at least one processor configured to read the computer readable medium, wherein the program code is configured to be executed by the at least one processor.

28. The apparatus of claim 26, wherein the program code is further configured to identify a plurality of combinations of terms in the text collection and, for each of the plurality of combinations of terms, calculate co-occurrences thereof at each of a plurality of positional variances therebetween.

29. The apparatus of claim 28, wherein the program code is further configured to process a query on the text collection using the calculated co-occurrences for the plurality of combinations of terms by generating a query set including at least one combination of terms for which a co-occurrence has been calculated and a positional variance therefor.

30. The apparatus of claim 29, wherein the program code is configured to generate the query set by calculating a plurality of term variances for each of a plurality of combinations of terms, and selecting a subset of the plurality of combinations of terms for inclusion in the query set based upon the plurality of term variances, wherein each term variance for each combination of terms is associated with a specific positional variance between the terms in the combination of terms, and wherein each combination of terms in the selected subset has a specific positional variance associated therewith.

31. The apparatus of claim 30, wherein the program code is configured to process the query by searching the text collection for each combination of terms in the selected subset at the specific positional variance associated therewith, and ranking each of a plurality of matching documents from the text collection based upon an aggregation of the term variances for those combinations of terms in the selected subset that are found in such matching document.

32. An apparatus, comprising:
a computer readable medium; and
program code resident in the computer readable medium and configured to process a query by calculating a plurality of term variances for at least one term combination associated with a query, generating a query set based upon the plurality of calculated term variances, and querying a text collection using the generated query set, wherein each term variance is associated with a specific positional variance between the term combination.

33. The apparatus of claim 32, further comprising at least one processor configured to read the computer readable medium, wherein the program code is configured to be executed by the at least one processor.

34. The apparatus of claim 33, further comprising a massively parallel relational database system within which the text collection is resident, wherein the program code is configured to query the text collection by accessing the massively parallel relational database system.

35. The apparatus of claim 32, wherein the program code is configured to calculate the plurality of term variances by calculating a plurality of term variances for each of a plurality of term combinations associated with the query, and to generate the query set by selecting a subset of the plurality of term combinations and associated positional variances therefor based upon the respective term variances of the plurality of term combinations.

36. The apparatus of claim 35, wherein the program code is configured to calculate the plurality of term variances by calculating, for each positional variance, the term variance therefor by dividing a number of co-occurrences of the term combination at such positional variance in the text collection by an average frequency of co-occurrence for the term combination over all positional variances.

37. The apparatus of claim 36, wherein the program code is configured to calculate the plurality of term variances further by weighting each term variance based upon the positional variance associated therewith.

38. The apparatus of claim 35, wherein the program code is configured to query the text collection by searching the text collection for each term combination in the selected subset at the specific positional variance associated therewith, and ranking each of a plurality of matching documents from the text collection based upon an aggregation of the term variances for those term combinations in the selected subset that are found in such matching document.
